(19) United States
(12) Patent Application Publication
(10) Pub. No.: US 2005/0098682 A1
(43) Pub. Date: May 12, 2005

(54) Light weight helicopter

(76) Inventor: Bhaskar Ramchandra Pai, Karnataka (IN)

Correspondence Address: HARNESS, DICKEY & PIERCE, P.L.C., P.O. BOX 828, BLOOMFIELD HILLS, MI, 48303, US

(21) Appl. No.: 10/380,904

(22) PCT Filed: Feb. 7, 2001
(86) PCT No.: PCT/IN01/00016

(51) Int. Cl. B64C 27/00

(52) U.S. Cl. 244/17.11

(57) ABSTRACT

The present invention relates to a lightweight helicopter, comprising of a rotary wing (1) unit and a frame assembly (2), the rotary wing consists of an engine (3) with a primary gear box (7), mounted below a keel post (8) and the keel post attached to a triangular control frame (28), the base of which forms the control bar (29), and is also provided with a tail plane (12) having one or more vertical articulable flaps (34). A secondary gearbox is provided with means capable of transmitting the rotary movement of the said engine to two horizontal rotors (9, 10) capable of pitch change. The rotary wing unit is suspended by means to a frame assembly having means (47) for pilot seating, landing gear (46) and provided with means for control of the engine, rotors, tailplane and landing gear.

### TECHNICAL FIELD

The present invention relates to a lightweight helicopter.

### BACKGROUND AND PRIOR ART

The present invention provides for a lightweight helicopter which is simple to operate and affordable for individuals or groups for purposes of aero-sports and hobby flying. While a number of affordable aircraft such as ‘microlights, powered hang gliders have brought the possibilities of powered flight within the reach of general public, leading to an upsurge in aerosports, the same is not true of the helicopter. The helicopter remains an expensive machine to acquire and difficult to learn to operate and to fly safely. For example a single seater, powered hand glider manufactured indigenously is available for about Rs.2.0 lakhs and requires about 10-15 hours instruction before an average person can fly solo. On the other hand, the recently introduced single seater “Ultralight Helicopter”, the Ultrasport 254 in the USA costs around $35,000 (Rs. 15 lakhs) in kit form and would require expensive training in a 2-seater helicopter, which may require 100 hrs and cost Rs.6-8 lakhs for the training. This difference arises mainly due to the increased complexity of the conventional helicopter, which results in an expensive machine, which is difficult to learn to fly. However, the ability of a helicopter for vertical as well as forward movement, makes it very attractive as a flying machine and would certainly prove to be very popular if made simple to fly and affordable.

This is the objective of the present invention.

Reference may be made to U.S. Pat. No. 5,370,341, December 1994 by Ross Leon for “an ultralight helicopter and control system” which consists an ultralight helicopter with a pair of counter—rotating rotor assemblies. In this invention the pilot is suspended in a supine position in a hang glider type harness under the rotors. The pilot holds a control bar fixed to a frame and maneuvers the helicopter in pitch and roll directions by manipulating the control bar which results in the shift of his centre of gravity relative to the centre of gravity of the helicopter, thereby tilting the thrust axis of the rotors resulting in the maneuvering of the helicopter. The pilot also operates the engine throttle and pitch control mechanism of the rotor bladders with twist-grips formed on the control bar. With this control he can control the vertical movement of the aircraft. This invention has several drawbacks: since the pilot is freely suspended in a supine position under the downwash of the rotors, it is likely that it will lead to large swaying and buffetting of the pilot, making it difficult to control the aircraft. The supine (face downward) position is also considered to be extremely dangerous from a crash-worthiness point of view. Another drawback of the invention is that in hover and low forward speeds, the absence of a positive control in the yaw direction could lead to undesirable spinning of the pilot about a vertical axis. It appears very difficult to introduce any further controls to overcome this problem, since both the hands of the pilot are fully occupied in manipulating the control bar, the rotor blade pitch control and the engine throttle and the pilots' feet are not available to carry out any control function because of the supine, freely hanging position.

The use of two counter-rotating rotors is employed in some helicopters, such as for example, the Kamov helicopter of Russian origin and reported in Janes “Aircraft of the World”. The use of counter-rotating concentric rotors has the advantage of having a zero net angular momentum thus avoiding the requirement of a tail rotor for torque balancing required in the single main—rotor arrangement as in the conventional helicopters. There is a saving in power normally consumed by the tail rotor of a conventional helicopter. However, due to the lower rotor being placed in the wake of the upper rotor, there is an interference effect which results in an increase in the power required for a given thrust, thus nullifying to some extent, the saving in power of the tail rotor. Another feature of the Kamov concentric contrarotating rotors in the use of differential pitch control of the two rotors for achieving control in the yaw direction. This machine therefore needs a collective pitch, a cyclic pitch and differential pitch arrangements for its control. With all these features, the mechanical complexity is very high, leading to an expensive and complex machine.

We can estimate the size of the rotors on the basis of the disk loading and power loading of lightweight machines in a similar class. FIG. 5 shows a plot of these parameters for five helicopters. It would appear that Ross-1 from Ref.[1] could turn out to be somewhat under powered. HT-1 (1) and HT-1 (2) are present designs, one fitted with a 42-hp Rotax 477-2V engine and a 50 hp, Rotax 503-2V engine respectively. The weight estimates for each aircraft design indicates that the HT-1 (1) would weigh about 115 kg and HT-1 (2) would weigh about 127 kg. Thus the HT-1 (1) could achieve the ultralight category but it may be somewhat under-powered and the HT-1 (2) could have sufficient power but would not meet the ultralight category weight limit.

### OBJECTS OF THE INVENTION

The main object of the present invention is to provide lightweight helicopter of simplified construction, which is simple to fly and overcomes the drawbacks noted above. This machine is appropriately termed as “helitrike”.

### DETAILED DESCRIPTION OF THE INVENTION

Accordingly, the present invention provides a lightweight helicopter of simplified construction, which is simple to fly and is appropriately termed as “helitrike”.

The detailed description of the helitrike is described hereunder with the help of the following drawings.

### BRIEF DESCRIPTION OF THE ACCOMPANY DRAWINGS

The details of the helicopter of the present invention are shown in FIGS. 1-4 of the drawings accompanying this specification.

FIG. 1 shows the side view of helitrike.

FIG. 2 shows the front view of helitrike.

FIG. 3 shows a cross-sectional view of the secondary gearbox.

FIG. 4 shows a view of the suspension arrangement.

FIG. 5 is a plot of power loading and disk loading of some typical light helicopters.

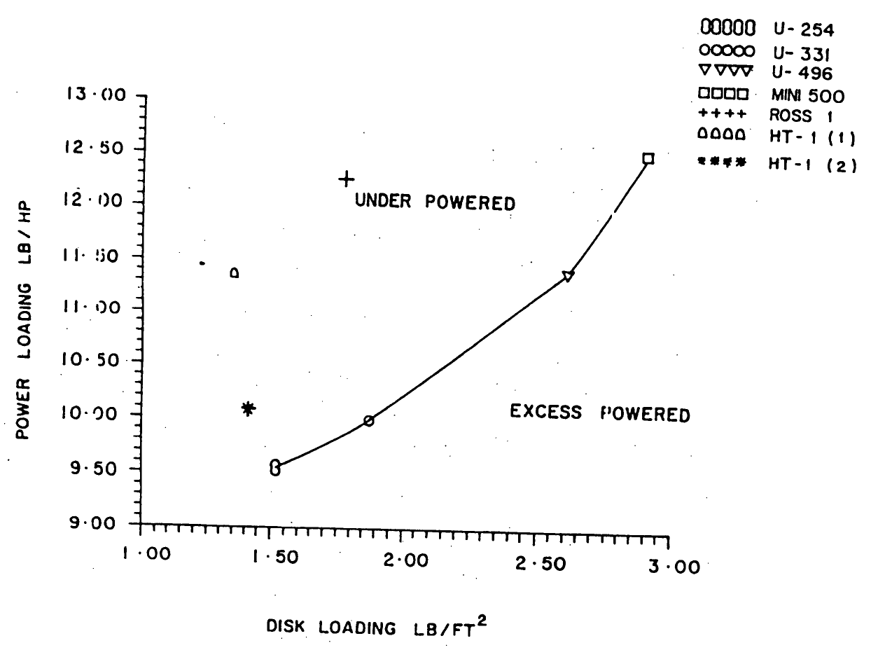

Accordingly, the present invention provides a light weight helicopter which comprises: a rotary wing unit (1) consisting of an engine (3) with a primary gearbox (4) connected through flexible coupling (5) and sprag clutch (6) to a secondary gear box (7), the engine and gearbox assembly being mounted below a horizontal keel post (8) by means (20) such as flexible mounts, the said keel post being also rigidly attached to a triangular control frame (28), the base of which forms the control bar (29), to the said keel post being also fixed a fuel tank (11) connected to the said engine, the keel post being also provided with a tail plane (12) having one or more verticle articulable flap (34) capable of being articulated by means (40) such as a cable, the said secondary gearbox (7) being provided with means (18, 17, 16, 15) capable of transmitting the rotary movement of the said engine (3) to two contra rotating vertical concentric shafts (13, 14) each of which being fixed by means (22, 23, 24) to horizontal rotors (9, 10) the said rotors having at least two bidirectional rotor blades (21) capable of pitch change through axial movement by means (25, 26, 19), the above rotary wing unit (1) being suspended by means (49, 50) to a tricycle assembly (2) having means for pilot seating, landing gear and provided with means for control of the engine, rotors, tailplane and landing gear.

In an embodiment of the present invention, the engine used may be such as a 2-stroke reciprocating petroil engine, or a Wankel rotary engine of high power to weight ratio.

In another embodiment of the present invention, there is provided a control frame capable of articulating the rotary wing unit (I) through a control bar held by the pilot.

In another embodiment of present invention, there is provided articulable flaps capable of being articulated by means such as cable controllable by the pilot.

In yet another embodiment of the present invention, wherein the means used for changing of rotor blade mean pitch may be such as star and turnbuckle arrangement.

In yet another embodiment of the present invention, the means for activating the change in rotor blade mean pitch is a rotable twist grip locate on the control bar and controlled by the pilot.

In still another embodiment of the present invention, wherein the means used for suspending the tricycle assembly from the keel of the rotary wing unit is selected from stirrup and hang bolt arrangement.

In another embodiment of the present invention, wherein the landing system is selected from wheels, skids or floats.

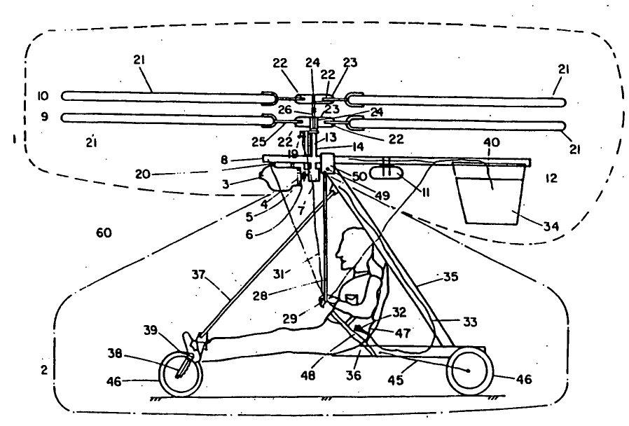

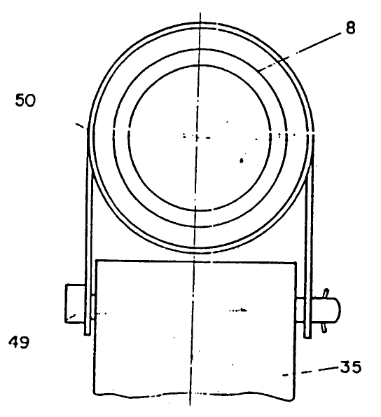

The invention will now be described in detail with reference to FIGS. 1 to 4.

The helicopter of the present invention as shown in FIGS. 1 & 2 comprises of the rotary wing assembly (I) and the tricycle assembly (2).

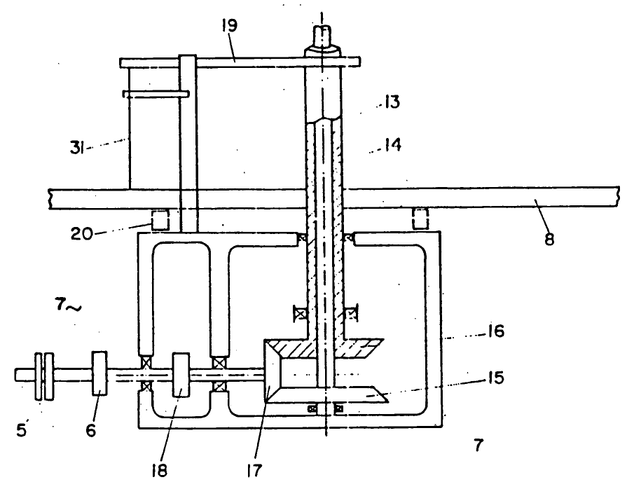

The rotary wing assembly (1) comprises the engine (3) with the primary gearbox (4), connected through flexible coupling (5) and sprag clutch (6) to the secondary gearbox (7). The secondary gearbox (7) and the engine (3) are mounted below keel post (8) through flexible mounts (20). The secondary gearbox (7) drives two contra-rotating rotors, (9, 10). The keel post (8) also carries the fuel tank (11) and the articulated tail (12). The secondary gearbox (7) as detailed in FIG. 3 houses a pair of concentric shafts (13) and (14) connected to bevel gears (15, 16). These bevel gears engage the pinion gear (17), connected through freewheeling clutch (18) to the engine through the sprag clutch (6) and flexible coupling (5).

The rotor blades (21) are supported on the concentric shafts (13, 14) through pitch bearings (22) on the teetering plates (23) and teetering hinges (24). The pitch horns (25) on each rotor blade is connected to the star and turnbuckle mechanism (26), which rotates with the rotors.

The stationary control fork (19) provides axial movement of the star and turnbuckle mechanism (26), which results in the simultaneous pitch change of the rotor blades under the control of the pilot. The rotary wing assembly (1) is also rigidly connected to the triangular control frame (28), the base of which forms the control bar (29). The control bar (29) has concentric twist grips (30) which are linked to the control fork (19) through flexible cable (31), to enable the change in the pitch angle of the rotor blades. The engine (3) is connected to hand throttle lever (32) near the pilot's hand through flexible throttle cable (33). The tail plane (12) has an articulated lower portion (34), which is a hinged flap or a plurality or flaps and can be rotated about a horizontal axis for yaw control.

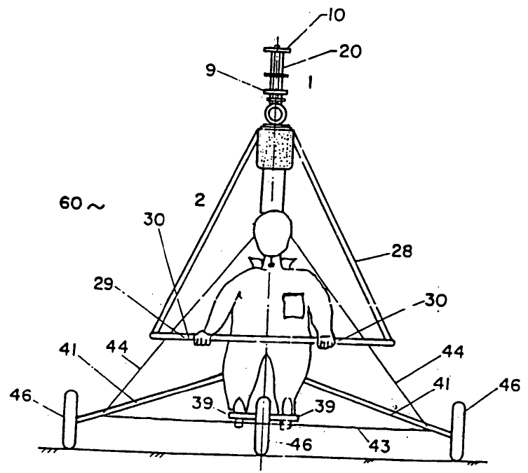

An embodiment of the tricycle assembly of the present invention is shown in the FIGS. 1 and 2, the tricycle assembly (2) comprises a triangular frame composed of the vertical beam (35), the horizontal beam (36) and the front tube (37). The horizontal beam (36) supports the front fork (38) in a pivot. The front fork (38) has footrest (39) for the pilot, the front fork (38) also has attachment to cables (40) linking to the articulated vertical flap (34), such that a rotation of the fork results in the hinge movement of the flap. The horizontal tube (36) also supports landing tube (41), which are kept in position through tensioned cables such as (43), (44) and (45). The landing tube (41) and the front fork (38) support tyred wheels (46). The pilot is seated in a seat (47) fixed on the horizontal beam (36) and secured firmly through seat belts (48). The tricycle assembly is attached to the rotary wing unit (I) through a hang bolt (49) linking a stirrup (50) overlaying the keel post (8). This arrangement permits the relative movement between the rotary wing unit and the tricycle in the pitch and roll directions.

While this is the suggested configuration, numerous variations on the shape of the trike and wheel support are feasible as is known in construction of powered hang gliders or ‘trikes’.

Method of Operation

Engine Starting

During starting, the engine is automatically disconnected from the rotors because of the sprang clutch (6). The engine is started in a conventional way, using recoil or electric start. As the engine speed picks up, the sprag clutch (6) engages at a particular speed and causes the contra-rotating rotors to rotate, causing a downward thrust. The pilot can adjust the thrust by selection of the engine speed and the blade pitch.

Flying

Flying the helicopter of the present invention would have similarly with flying a helicopter as well as flying a powered hang glider (“trike”). With the correct power and collective pitch setting, the helitrike will get into the hover mode. The pilot would make adjustments to the control bar in pitch direction (i.e. force and aft movement) which tilts the thrust axis accordingly and also sideways to control the roll movement. To move forward, the control bar is pulled back which causes the thrust axis to point backwards giving a forward thrust.

To turn left, the control bar is pushed to the right and vice versa to turn right, much like in a powered hang glider. In all these maneuvers, the weight of the pilot and trike provide the reaction force to tilt the thrust axis of the rotors in the required direction. As the net angular momentum of the contra-rotating rotors is zero, the control force required is expected to be small and within the comfort limits of a person. Yaw control is achieved through manipulation of the tail vane through rotation of the front fork in the manner of steering on the ground. As the vane is positioned in the downwash of the rotors, adequate yaw control in hover as well as low forward speed is expected. For high forward speeds, the tail vane would “weathercock” into the wind and the articulated vane could be placed in a neutral position. Spot turns, an important maneuver for helicopters would be possible with the present system. In the event of engine failure, the helitrike would get into an auto-rotation mode. This means that the rotors would be free to rotate due to the freewheel 18, and continue to provide lift. It is of course necessary for the pilot to reduce the collective pitch and to go through the autorotation drill as for any conventional helicopter; finally achieving a ‘flare’ or increase in collective pitch to increase the thrust and reduce the rate of descent at touch down.

It is thus expected the helicopter of the present invention would be quite a simple machine to fly, akin to a powered hang glider. Typically, an average student can go solo after about 15-hrs training in a powered hang glider. This is much less than for a regular helicopter training and similar figures may be expected for a helicopter of the present invention. Thus, the helicopter of the present invention could provide an affordable and safe flying machine, with all the advantages of a regular helicopter at a much lower cost.

The determination of the basic dimensions of the helicopter is now discussed. The area of the rotors and the power requirements of the helicopter are obtained from reference to conventional machines of similar performance. It is proposed to design a very light machine which could meet the US “Ultralight” category (FAR Part 103) for which special relaxations are available, such as not requiring a license to fly etc. This requires the empty weight of the aircraft, not to exceed 254 lb (115.3 kg). We may have the following target weights:
Empty weight of aircraft: 115.3 kg
Pilot weight: 90.0 kg
Fuel: 10.0 kg
All up weight: 215.3 kg

The expected performance of a helitrike as described above fitted with a Rotax 447-2V, 40 HP engine operating at 6500 rpm is estimated. Our calculation based on the simple momentum theory described by Seddon in the book on basic helicopter Aerodynamics (1990) indicates a rate of climb in vertical ascent of 4.4 m/s (870 ft/min.). The machine would have a autogyration capability which means that in the event of engine failure, the pilot can have a controlled descent by controlling the collective pitch of the rotor blades and a smooth landing could be obtained by “flaring” (i.e. sudden increase of pitch) just before the touch down.

The expected performance of a helitrike as described above fitted with a Rotax 503-2V, 50 hp engine operating at 6200 rpm is estimated. Our calculations indicate a rate of climb of 6.2 m/s (1220 ft per minute). This indicates a good performance and adequate reserve of power to get out of difficult situations such as downdrafts or turbulence. The machine could take off from a small piece of land in a near vertical direction and move forward once a certain height is achieved. The helitrike could execute the routine maneuvers such as spot turns, hover, vertical descent and landing.

In all these above-mentioned maneuvers, the pilot controls the movement of the helicopter mainly through the movement of the control bar in his hands. By pulling the bar towards him, the thrust axis of the rotor tilts backwards, thus pushing the helicopter forward. A push of the bar to the left causes the helicopter to move to the right, and pushing the bar forward can reduce the forward speed. Thus by shifting the weight of the trike and pilot relative to the rotary wing assembly, he can simply maneuver the helicopter. For vertical movements he can increase the engine throttle and/or the collective pitch of the rotor blades. As he is sitting firmly in a seat, which has only two degrees of freedom, he will not be thrown around due to the rotor down wash. Moreover, with his feet he can rotate the front fork, thereby controlling the vertical hinged flap and face in the direction he wants to go.

The main advantages of the present invention are
1. The control and control mechanism of the helicopter are simplified as there is no cyclic pitch control mechanism as in conventional helicopters and the pilot can control the direction of flight simply by pulling nor pushing of the control bar.
2. As the pilot is firmly seated in a seat in the trike which is suspended with only 2-degrees of freedom, he can easily control the buffeting which may be experienced in the downwash of the rotors.
3. As the pilot is seated in a trike, his feet are available for controlling the front fork and thereby control the yawing motion of the helicopter.
4. It has all the advantages of a helicopter such as ability to hover, vertical ascent and descent, forward flight etc. at a much lower cost and ease of operation.

1-8. (canceled)

9. A light weight helicopter which comprises a rotary wing unit (1) having an engine (3) with a primary gearbox (4) being connected through flexible coupling (5) and centrifugal clutch (6) to a secondary gear box (7), the said engine, the primary and the secondary gearbox assemblies being mounted below a horizontal keel post (8) using mounting means (20), the said keel post being also rigidly attached to a triangular control frame (28), a base portion of which forms a control bar (29), the said keel post being fixed to a fuel tank (11) and being connected to said engine, the said keel post being also provided with a tail plane (12) having one or more articulated vertical flap (34) capable of being articulated by cable means (40), the said secondary gearbox being provided with freewheeling clutch (18), pinion gear (17) and bevel gears (15&16) capable of transmitting the rotary movement of the said engine to two contra rotating vertical concentric shafts (13&14) each of which being fixed by pitch bearing (22) on the teetering plates (23) and teetering hinges (24) to horizontal rotors (9, 10), the said horizontal rotors having at least two rotor blades of airfoil cross section (21) capable of pitch change through rotary movement of pitch horn (25), the said pitch horn on each rotor blade being connected to star and turnbuckle mechanism (26) and stationary control fork (19), the said rotary ring unit being attached to a tricycle assembly (2) through a landing gear (46) and provided with means for control of the said engine, rotors, tail plane and landing gear, said tricycle assembly having a triangular frame composed of a rear beam (35), a horizontal beam (36) and a front tube (37), the said horizontal beam supporting a front fork (38) in a pivot, the said front fork being provided with footrest (39) for the pilot, the said front fork being attached to cables (40) linking to the said articulated vertical flap, such that the rotation of the said front fork resulting in the hinge movement of the flap, the said horizontal tube also supporting a plurality of landing gear tubes (41), which are kept in position trough tensioned cables (43), (44) and (45), the said landing tubes and the front fork supporting landing gear (46), the pilot being seated in a seat (47) fixed on the said horizontal beam and secured firmly to the seat through seat belts (48).

10. A lightweight helicopter as claimed in claim 9 wherein, the engine used is selected from a 2-stroke reciprocating petrol engine, or a Wankel rotary engine of high power to weight ratio as herein described.

11. A light weight helicopter as claimed in claim 9 wherein, a triangular control frame articulates the rotary ring unit through a control bar held by the pilot.

12. A light weight helicopter as claimed in claim 9 wherein, the means for activating the change in rotor blade mean pitch is a rotatable twist grip located on the control bar and controlled by the pilot.

13. A lightweight helicopter as claimed in claim 9 wherein, the landing gear is selected from tyred wheels, skids or floats.
